(19) United States
(12) Patent Application Publication
(10) Pub. No.: US 2022/0380015 A1
(43) Pub. Date: Dec. 1, 2022

(54) Mechanical Arm and A UAV

(71) Applicant: Shanghai Autoflight Co., Ltd., Kunshan City (CN)

(72) Inventor: Yu Tian, Hong Kong SAR (CN)

(21) Appl. No.: 17/827,295

(22) Filed: May 27, 2022

(30) Foreign Application Priority Data
May 31, 2021 (CN) 202121186247.9

(51) Int. Cl. B64C 1/06; B64C 39/02; B64D 27/24

(52) U.S. Cl. CPC B64C 1/06; B64C 39/024; B64D 27/24; B64C 2201/042; B64C 2201/108; B64D 33/08

(57) ABSTRACT

A mechanical arm having a shell and a lift power unit. A holding chamber is arranged in the mechanical arm shell, the lift power unit part is arranged in the holding chamber, the upper wall surface of the mechanical arm shell is provided with a first heat dissipation hole and a second heat dissipation hole. The first heat dissipation hole and the second heat dissipation hole are located on each side of the lift power unit, respectively. The lower wall surface of the mechanical arm shell is provided with a third heat dissipation hole and a fourth heat dissipation hole, and the third heat dissipation hole and the fourth heat dissipation hole are located on each side of the lift power unit, respectively.

### TECHNICAL FIELD

The application relates to the technical field of UAV (unmanned aerial vehicle), in particular to a mechanical arm and a UAV.

### BACKGROUND ART

UAV is an unmanned aircraft manipulated by radio remote control equipment and self-contained program control device. For the existing high-power vertical takeoff and landing (VTOL) UAV, the motor and electric regulator in the lift power unit have high power and large calorific value in the VTOL stage of the UAV. However, the mechanical arm generally has a closed chamber structure, which is not conducive to the heat dissipation of motor and electric regulator. Moreover, due to the limited internal space of the mechanical arm of existing high-power VTOL UAV, the motor and electric regulator have occupied most of the internal space, and goes through various high-power cables. It is not easy to set heat dissipation elements inside the mechanical arm. In addition, the takeoff weight of high-power vertical take-off and landing (VTOL) UAV is strictly limited, and adding too heavy heat dissipation elements may increase the weight, which is not applicable to high-power VTOL UAV. Therefore, it provides a mechanical arm and a UAV to solve the above problems.

### SUMMARY OF THE APPLICATION

The purpose of the application is to provide a mechanical arm, which have good heat dissipation performance, so as to facilitate the heat generated by the lift power unit to be transmitted to the external environment, thereby guaranteeing the safe operation of the lift power unit and extending its service life.

To this end, the application adopts the following technical solution:

A mechanical arm, which comprises a mechanical arm shell and a lift power unit, a holding chamber is arranged in the mechanical arm shell, and the lift power unit is partially arranged in the holding chamber. The upper wall surface of the mechanical arm shell is provided with a first heat dissipation hole and a second heat dissipation hole, and the first heat dissipation hole and the second heat dissipation hole are located on each side of the lift power unit, respectively. The lower wall surface of the mechanical arm shell is provided with a third heat dissipation hole and a fourth heat dissipation hole, and the third heat dissipation hole and the fourth heat dissipation hole are located on each side of the lift power unit, respectively. A gap is arranged between the lift power unit and the wall of the mechanical arm shell, and the gap connects the holding chamber and the outside.

The first heat dissipation hole is closer to the fuselage than the second heat dissipation hole;

And/or, the third heat dissipation hole is closer to the fuselage than the fourth heat dissipation hole.

It also includes a wind shield, which is rotatably connected with the inner wall of the mechanical arm shell, and the wind shield is arranged at the first heat dissipation hole, the second heat dissipation hole, the third heat dissipation hole and the fourth heat dissipation hole, so that the air flow can flow in from the first heat dissipation hole, the second heat dissipation hole, the third heat dissipation hole and the fourth heat dissipation hole without flowing out.

It also includes a first deflector, which is arranged in the holding chamber to guide the air flow through the heating position of the lift power unit.

It also includes a second deflector, which is arranged in the holding chamber to guide the air flow to flow spirally along the circumferential direction of the lift power unit.

The inner wall of the mechanical arm shell is coated with a heat conducting layer.

It also includes a heat conducting member, with one end connected to the heating position of the lift power unit, and the other end arranged at the outer wall surface of the mechanical arm shell.

A plurality of the first heat dissipation hole, the second heat dissipation hole, the third heat dissipation hole and the fourth heat dissipation hole are all provided.

Another purpose of the application is to provide a UAV, of which the mechanical arm can have good heat dissipation performance, so as to facilitate the heat generated by the lift power unit to be transmitted to the external environment, thereby guaranteeing the safe operation of the lift power unit and extending its service life.

To this end, the application adopts the following technical solution:

A UAV, which comprises a fuselage and the mechanical arm.

A plurality of mechanical arms are provided, and the plurality of mechanical arms are arranged at intervals along the circumferential direction of the fuselage.

The beneficial effects of the application are as follows:

The application provides a mechanical arm, which comprises a mechanical arm shell and a lift power unit. A holding chamber is arranged in the mechanical arm shell, and the lift power unit is partially arranged in the holding chamber. The upper wall surface of the mechanical arm shell is provided with a first heat dissipation hole and a second heat dissipation hole, and the first heat dissipation hole and the second heat dissipation hole are located on each side of the lift power unit, respectively. The lower wall surface of the mechanical arm shell is provided with a third heat dissipation hole and a fourth heat dissipation hole, and the third heat dissipation hole and the fourth heat dissipation hole are located on each side of the lift power unit, respectively. A gap is arranged between the lift power unit and the wall surface of the mechanical arm shell, and the gap connects the holding chamber and the outside. The application also provides a UAV, which comprises a fuselage and the mechanical arm. During the lifting and lowering process of the UAV, the air flow will flow into the holding chamber from the first heat dissipation hole, the second heat dissipation hole, the third heat dissipation hole and the fourth dissipation hole, respectively, and flow out from the gap between the lift power unit and the wall surface of the mechanical arm shell. When the air flows in the holding chamber, it can absorb the heat generated by the lift power unit and bring to the external environment to realize the heat dissipation inside the mechanical arm, thereby guaranteeing the safe operation of the lift power unit and extending its service life.

### DESCRIPTION OF THE FIGURE(S)

FIG. 1 is the sectional view of the mechanical arm provided by the embodiment of the application.

Wherein,
1. Mechanical arm shell; 2. Lift power unit; 3. The first radiating hole; 4. The second heat dissipation hole; 5. The third heat dissipation hole; 6. The fourth heat dissipation hole.

### DETAILED DESCRIPTION

The technical solution of the application is further described below in combination with the drawings and the embodiments. It can be understood that the preferred embodiments described here are only used to explain the application, rather than to limit the application. In addition, it should be noted that for the convenience of description, only some parts related to the application are shown in the drawings, not all.

In the description of the application, it should be noted that unless otherwise specified and limited, the terms “installation”, “connect” and “connection” should be understood in a broad sense. For example, it can be fixed connection or detachable connection. It can be mechanical connection or electrical connection. It can be connected directly or indirectly through an intermediate medium, and it can be the connection between the two components. For those skilled in the art, the specific meaning of the above terms in the application can be understood in specific circumstances.

In the application, unless otherwise clearly specified and limited, the first feature “on” or “under” the second feature may include the direct contact between the first and second features, or the contact between the first and second features that is not direct contact, but through another feature between them. Moreover, the first feature “on”, “over”, and “above” the second feature may include the first feature directly above and obliquely above the second feature, or only indicates that the horizontal height of the first feature is higher than the second feature. The first feature “under”, “below” and “beneath” the second feature, may include the first feature directly below and obliquely below the second feature, or only indicate that the horizontal height of the first feature is smaller than that of the second feature.

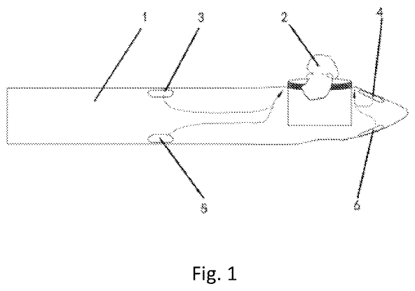

As shown in FIG. 1, this embodiment provides a mechanical arm, which comprises a mechanical arm shell 1 and a lift power unit 2. A holding chamber is arranged in the mechanical arm shell 1, and the lift power unit 2 is partially arranged in the holding chamber. In order to enable the heat transfer of the holding chamber to the outside, a plurality of heat dissipation holes are arranged on the mechanical arm shell 1, including a first heat dissipation hole 3 and a second heat dissipation hole 4 arranged on the upper wall surface of the mechanical arm shell 1. The first heat dissipation hole 3 and the second heat dissipation hole 4 are located on each side of the lift power unit 2, respectively. A third heat dissipation hole 5 and a fourth heat dissipation hole 6 are arranged on the lower wall surface of the mechanical arm shell 1. The third heat dissipation hole 5 and the fourth radiating hole 6 are located on each side of the lift power unit 2, respectively. A gap is arranged between the lift power unit 2 and the wall surface of the mechanical arm shell 1, and the gap connects the holding chamber and the outside. During the lifting process of the UAV equipped with the mechanical arm, the external air flow will flow into the holding chamber from the first heat dissipation hole 3, the second heat dissipation hole 4, the third heat dissipation hole 5 and the fourth heat dissipation hole 6, respectively, and flow out from the gap between the lift power unit 2 and the wall surface of the mechanical arm shell 1. When the air flows in the holding chamber, it can absorb the heat generated by the lift power unit 2 and bring to the external environment to realize the heat dissipation inside the mechanical arm, thereby guaranteeing the safe operation of the lift power unit 2 and extending its service life.

The first heat dissipation hole 3 is closer to the fuselage than the second heat dissipation hole 4. That is, the first heat dissipation hole 3 is close to the fuselage, and the second heat dissipation hole 4 is relatively far away from the fuselage. The third heat dissipation hole 5 is closer to the fuselage than the fourth heat dissipation hole 6. That is, the third heat dissipation hole 5 is close to the fuselage, and the fourth heat dissipation hole 6 is relatively far away from the fuselage. This arrangement can ensure that the air flow flows in from each heat dissipation hole and then flows out through the gaps on both sides of the lift power unit 2, so that the heat generated by the lift power unit 2 can be transferred out in a balanced manner.

The mechanical arm also includes a wind shield (not shown in the FIGURE), which is rotatably connected with the inner wall of the mechanical arm shell 1, and the wind shield is arranged at the first heat dissipation hole 3, the second heat dissipation hole 4, the third heat dissipation hole 5 and the fourth heat dissipation hole 6, so that the air flow can flow in from the first heat dissipation hole 3, the second heat dissipation hole 4, the third heat dissipation hole 5 and the fourth heat dissipation hole 6 without flowing out. When the air pressure at the upper wall surface is different from that at the lower wall's, in order to prevent the air flow from flowing in from one heat dissipation hole and flowing out from another heat dissipation hole, the wind shield is arranged at each heat dissipation hole. It can be seen that the wind shield is arranged in the holding chamber with one end rotatably connected with the inner wall of the mechanical arm shell 1 and the other end butted with the inner wall. When the air flow flows in from the heat dissipation hole, it will push the wind shield to rotate to open the heat dissipation hole. When the air flow flows out from the heat dissipation hole, it will push the wind shield to rotate to close the heat dissipation hole, thus preventing the air flow from flowing out of the heat dissipation hole and affecting the heat dissipation effect. It can be seen that the rotation direction of the wind deflector should be arranged according to the flow direction of the air flow.

The mechanical arm also includes a first deflector (not shown in the FIGURE), which is arranged in the holding chamber to guide the air flow through the heating position of the lift power unit 2. When the first heat dissipation hole 3 is arranged opposite to the third heat dissipation hole 5, one end of the first deflector can be arranged in the middle of the air flow flowing from the first heat dissipation hole 3 and the third heat dissipation hole 5, that is, the plate surface at one end of the first deflector is perpendicular to the connecting line between the first heat dissipation hole 3 and the third heat dissipation hole 5, so as to change the air flow direction and guide the air flow to the lift power unit 2 along the length direction of the mechanical arm. The other end of the first deflector extends towards the heating position of the lift power unit 2 so that part of the air flow reaches the heating position. Of course, in other embodiments, the first deflector can also be arranged in other forms, provided that, it can guide the air flow through the heating position of the lift power unit 2.

The mechanical arm also includes a second deflector (not shown in the FIGURE), which is arranged in the holding chamber to guide the air flow to flow spirally along the circumferential direction of the lift power unit 2. The lift power unit 2 is cylindrical. The second guide plate in spiral shape is arranged on its outer wall along the circumferential direction to guide the air flow in the holding chamber to flow spirally around the outer wall of the lift power unit 2 until it reaches the gap, so as to increase the time of contact between the air flow and the lift power unit 2, thereby improving the heat exchange efficiency.

The inner wall of the mechanical arm shell 1 is coated with a heat conducting layer. The arrangement of the heat conducting layer may also accelerate the heat conduction from the holding chamber to the outside.

The mechanical arm also includes a heat conducting component (not shown in the FIGURE), one end of which is connected to the heating position of the lift power unit 2, and the other end of which is arranged at the outer wall surface of the mechanical arm shell 1. The heat conducting component can transmit heat from the heating position of the lift power unit 2 to the outer wall surface of the mechanical arm shell 1 to dissipate in the external environment, so as to further accelerate the heat transfer from the holding chamber to the outside.

A plurality of the first radiating holes 3, the second radiating holes 4, the third radiating holes 5 and the fourth radiating holes 6 are provided. Heat dissipation holes may be arranged at different distances from the fuselage to ensure the safety of the mechanism in the mechanical arm shell 1, sufficient air flow and improve the heat dissipation efficiency of the lift power unit 2.

The application also provides a UAV, which comprises a fuselage and the mechanical arm. The UAV is provided with a plurality of mechanical arms, which are arranged at intervals along the circumferential direction of the fuselage, without the limit on the number.

During the lifting and lowering process of the UAV, the air flow will flow into the holding chamber from the first heat dissipation hole 3, the second heat dissipation hole 4, the third heat dissipation hole 5 and the fourth heat dissipation hole 6, respectively, and flow out from the gap between the lift power unit 2 and the wall surface of the mechanical arm shell 1. When the air flows in the holding chamber, it can absorb the heat generated by the lift power unit 2 and bring to the external environment to realize the heat dissipation inside the mechanical arm, thereby guaranteeing the safe operation of the lift power unit 2 and extending its service life.

Obviously, the above embodiments of the application are only given to clearly illustrate the examples given by the application, rather than to limit the embodiment of the application. For those skilled in the art, other changes or alterations in different forms may be made on the basis of the above description. It is unnecessary and impossible to enumerate all the embodiments here. Any modification, equivalent replacement and improvement made based on the spirit and principles of the application shall fall within the breadth and scope of the claims of the application.

1. A mechanical arm, which is characterized by comprising a mechanical arm shell (1) and a lift power unit (2), a holding chamber is arranged in the mechanical arm shell (1), part of the lift power unit (2) is arranged in the holding chamber, and the upper wall surface of the mechanical arm shell (1) is provided with a first heat dissipation hole (3) and a second heat dissipation hole (4), the first heat dissipation hole (3) and the second heat dissipation hole (4) are located on each side of the lift power unit (2) respectively, the lower wall surface of the mechanical arm shell (1) is provided with a third heat dissipation hole (5) and a fourth radiating hole (6), the third heat dissipation hole (5) and the fourth heat dissipation hole (6) are located on each side of the lift power unit (2) respectively, a gap is arranged between the lift power unit (2) and the wall surface of the mechanical arm shell (1), and the gap connects the holding chamber and the outside.

2. The mechanical arm according to claim 1, which is characterized in that the first heat dissipation hole (3) is closer to the fuselage than the second heat dissipation hole (4); and/or, the third heat dissipation hole (5) is closer to the fuselage than the fourth heat dissipation hole (6).

3. The mechanical arm according to claim 1, which is characterized in that it further comprises a wind shield, the wind shield is rotatably connected with the inner wall of the mechanical arm shell (1), and the wind shield is arranged at the first heat dissipation hole (3), the second heat dissipation hole (4), the third heat dissipation hole (5) and the fourth heat dissipation hole (6), so that the air flow can flow in from the first heat dissipation hole (3), the second heat dissipation hole (4), the third heat dissipation hole (5) and the fourth heat dissipation hole (6), without flowing out.

4. The mechanical arm according to claim 1, which is characterized in that it also comprises a first deflector, which is arranged in the holding chamber to guide the air flow through the heating position of the lift power unit (2).

5. The mechanical arm according to claim 4, which is characterized in that it also comprises a second deflector, which is arranged in the holding chamber to guide the air flow to flow spirally along the circumferential direction of the lift power unit (2).

6. The mechanical arm according to claim 1, which is characterized in that the inner wall of the mechanical arm shell (1) is coated with a heat conducting layer.

7. The mechanical arm according to claim 1, which is characterized in that it also comprises a heat conducting part, with one end of the heat conducting part connected to the heating position of the lift power unit (2), and the other arranged at the outer wall surface of the mechanical arm shell (1).

8. The mechanical arm according to claim 1, which is characterized in that a plurality of the first heat dissipation holes (3), the second heat dissipation hole (4), the third heat dissipation hole (5) and the fourth heat dissipation hole (6) are arranged.

9. A UAV (unmanned aerial vehicle), which is characterized in that it comprises a fuselage and a mechanical arm according to claim 1.

10. A UAV (unmanned aerial vehicle), which is characterized in that it comprises a fuselage and a mechanical arm according to claim 2.

11. A UAV (unmanned aerial vehicle), which is characterized in that it comprises a fuselage and a mechanical arm according to claim 3.

12. A UAV (unmanned aerial vehicle), which is characterized in that it comprises a fuselage and a mechanical arm according to claim 4.

13. A UAV (unmanned aerial vehicle), which is characterized in that it comprises a fuselage and a mechanical arm according to claim 5.

14. A UAV (unmanned aerial vehicle), which is characterized in that it comprises a fuselage and a mechanical arm according to claim 6.

15. A UAV (unmanned aerial vehicle), which is characterized in that it comprises a fuselage and a mechanical arm according to claim 7.

16. A UAV (unmanned aerial vehicle), which is characterized in that it comprises a fuselage and a mechanical arm according to claim 8.

17. The UAV according to claim 9, which is characterized in that a plurality of mechanical arms is arranged at intervals along the circumferential direction of the fuselage.

18. The UAV according to claim 10, which is characterized in that a plurality of mechanical arms is arranged at intervals along the circumferential direction of the fuselage.

19. The UAV according to claim 11, which is characterized in that a plurality of mechanical arms is arranged at intervals along the circumferential direction of the fuselage.

20. The UAV according to claim 12, which is characterized in that a plurality of mechanical arms is arranged at intervals along the circumferential direction of the fuselage.
